(19) United States
(12) Patent Application Publication
(10) Pub. No.: US 2020/0095101 A1
(43) Pub. Date: Mar. 26, 2020

(54) GATE OPENERS FOR TRAILER HOPPERS

(71) Applicant: Darren Larson, Irma (CA)

(72) Inventor: Darren Larson, Irma (CA)

(21) Appl. No.: 16/579,039

(22) Filed: Sep. 23, 2019

(30) Foreign Application Priority Data
Sep. 21, 2018 (CA) 3018330

(51) Int. Cl. B66F 3/10; B60P 1/56

(52) U.S. Cl. CPC B66F 3/10; B60P 1/56

(57) ABSTRACT

An auger mountable gate control assembly for a hopper trailer with a gate, and including an actuator, a driver connected to the gate, a torque limiter, a keyed telescoping assembly and one or more universal joints. A bin mountable gate control assembly for a bin with a gate, and including an actuator, a driver connected to the gate, a force limiter, and visual indication system for flow and/or gate position. A hopper assembly for an auger, and including a housing, an inlet, a first actuator for raising and lowering the inlet, and a second actuator for moving a gate covering an opening of the auger.

### TECHNICAL FIELD

Gate openers for farming equipment.

### BACKGROUND

Truck hopper trailers are used to transport bulk products such as grain. The trailer hoppers typically have a bottom opening which is covered by a slidable gate during transit. The gate may be opened and closed by the applying a torque force to a capstan of a rack and pinion arrangement connected to the gate, or using a lever arrangement. A torque force to operate a rack and pinion arrangement may be applied by a manual turning of the capstan using a tool such as a wrench, which requires considerable physical labour, or through an automated opener system which uses a motor mounted to the trailer to apply the torque force. However, there are a number of disadvantages with such automated opener systems, the most prominent disadvantages being cost, longevity of the system, and reduction of trailer gate integrity.

For example, a Super-13 trailer typically has numerous trailer hopper gates, and the cost of automating each trailer gate involves the installation of a separate motor, as well as other necessary structural components to each gate. This may result in significant costs, as well as long installation times. The gate itself may also need to be modified to accommodate an automated system, and accordingly may negatively affect the integrity of the gate itself. Furthermore, electric units mounted directly to the hopper gates suffer from maintenance issues, as such units, which are mounted to the sides or bottom of the trailer, are typically exposed to impact from stones as well as excessive salt and moisture, which may damage their internal components.

### SUMMARY

In one embodiment, there is provided a trailer hopper having a gate and gate control assembly, the gate having a closed position and an open position, the gate control assembly having a length. The gate control assembly has an actuator mounted or mountable on an auger; a driver connected to the actuator through a keyed telescoping assembly for adjusting the length of the gate control assembly; and one or more universal joints between the actuator and the driver. There may be a torque limiter between the actuator and the driver.

In another embodiment, there is provided a gate control assembly for use with a bin having a gate, the gate having a closed position and an open position. The gate control assembly has an actuator mountable on the bin; a driver adapted to be secured to the gate; a force limiter mounted to the actuator; and a visual indication system for displaying any one of flow rate, and the positioning of the gate.

In yet another embodiment, there is provided a hopper assembly for an auger, the auger having an opening for receiving a product to be conveyed from a product outlet. The hopper assembly has a flexible housing, disposed above the opening of the auger, having an upper inlet; a first actuator configured to lower and raise the upper inlet of the housing; a gate mountable over the opening of the auger; and a second actuator configured to move the gate between an open position and a closed position.

These and other aspects of the device and method are set out in the claims.

### BRIEF DESCRIPTION OF THE FIGURES

Embodiments will now be described with reference to the figures, in which like reference characters denote like elements, by way of example, and in which:

FIG. 1 is a side view of a gate opening and closing assembly, according to one embodiment of the present invention, as mounted on an auger;

FIG. 2 is a side view of a bin opening and closing assembly according to another embodiment of the present invention, as mounted on a bin;

FIG. 3A is a side view of a mounting mechanism as found in the embodiment of FIG. 2;

FIG. 3B is a top view of the mounting mechanism shown in FIG. 3A;

FIG. 4 is a side view of a hopper assembly, according to another embodiment of the present invention, as mounted on a conveyer auger; and

FIG. 5A is a top view of a screen and flat plate for the hopper assembly of FIG. 4;

FIG. 5B is a side view of the screen of FIG. 5A; and

FIG. 5C is a top view of the hopper assembly of FIG. 4.

### DETAILED DESCRIPTION

Immaterial modifications may be made to the embodiments described here without departing from what is covered by the claims.

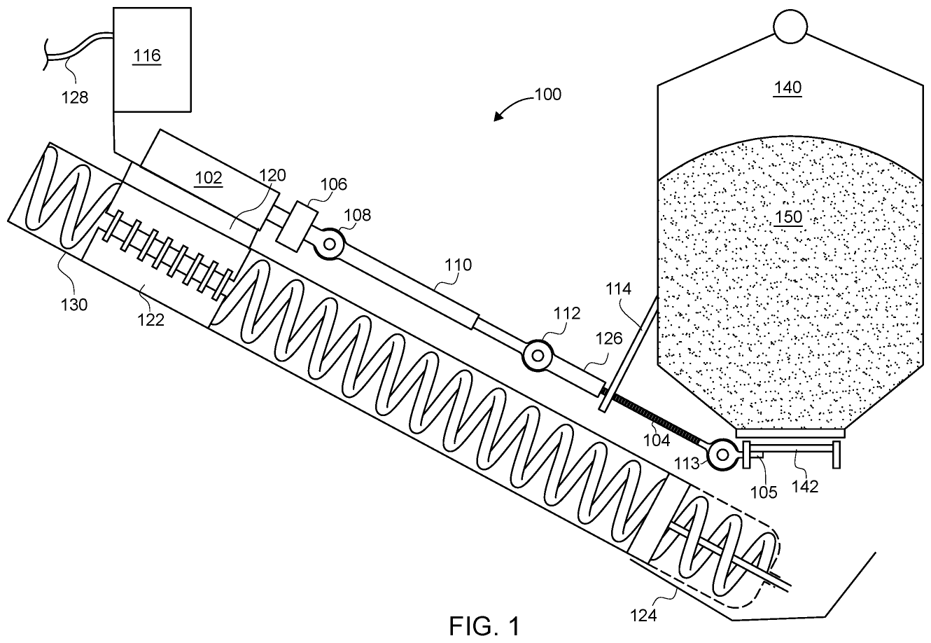

As shown in FIG. 1, there is provided a gate control assembly 100 (hereinafter, sometimes simply referred to as “assembly 100”) for a trailer hopper according to one embodiment of the present invention. This embodiment of the present invention allows for one actuator to be utilized for a plurality of hoppers, without the need to physically modify the hopper gate.

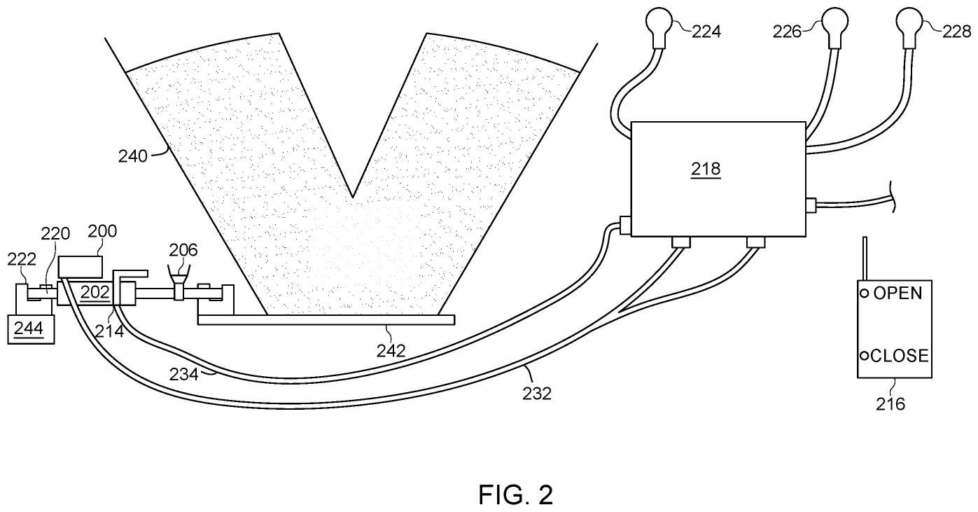

The assembly 100 may be used with a trailer hopper 140 (hereinafter, sometimes simply referred to as “hopper 140”). The view of FIG. 1 shows the hopper 140 as seen from the back of the trailer. The hopper 140 has a gate 142 which may be opened and closed. Along the length of the assembly, there is an actuator 102 which is mountable on an auger 130 which, in turn, receives products from the trailer hopper 140. Auger 130 may be a standard grain auger as represented by a schematic view in FIG. 1. In other embodiments, a belt type grain conveyer may be used. Also provided is a driver 104 secured to the hopper 140 by bracket 114. The driver 104 may include a rack and pinion arrangement as shown in FIG. 1, where a pinion 105 is connected to drive a rack on the underside of the gate 142 so that the gate moves perpendicularly to the plane of FIG. 1. The driver 104 may also include a universal joint 113 between the pinion 105 and the actuator side of the driver 104. This rack and pinion arrangement may be a conventional, hand operated rack and pinion arrangement supplied with the hopper. In the embodiment shown in FIG. 1, the actuator 102 connects to the pinion 105 of the rack and pinion to operate the rack and pinion to cause the gate 142 to open and close. Alternatively, a linear actuator could operate the sliding gate directly, as described below in relation to the embodiment of FIG. 2. In this case, the rack and pinion need not be removed but would freewheel when the assembly 100 is used.

When the gate is in an open position, product 150 can flow through the opening at the bottom of the hopper 140, and when the gate 142 is in a closed position, the opening of the hopper 140 is blocked. A catch basin 124 may catch the product 150 for the auger 130 to pick it up. The driver 104 and actuator 102 may be connected by a removable connection, for example using square tubing 126, to enable the auger and actuator to be easily separated from the hopper and driver. The auger may thus be moved from one hopper to another each hopper having its own gate and driver.

When the gate control assembly 100 is mounted on the auger 130, this allows the assembly to be used with a plurality of hoppers. One exemplary method of mounting the assembly 100 to the auger 130 is through a friction fit over the auger 130, which may be achieved by use of compression mounted split pipe bolted together. The assembly 100 may be mounted to the auger 130 using detachably interlocking members including a first member 120 and a second member 122, with the first member 120 mounted on the assembly 100 and the second member 122 mounted on the auger 130. The complementary interlocking system may allow the assembly 100 to be detached from one auger, such as the auger 130, and quickly installed on another auger with a pre-installed second member 122. In the embodiment shown in FIG. 1 second member 122 is compression mounted split pipe bolted together. In other embodiments, the second member could be a half pipe laid on top with a seat belt type strap or a bracket welded directly to the auger itself so long as the functionality of the auger is not compromised and the second member 122 will not slip under torque or vibration. The first member 120 may be any easily detachable mechanical fastener to secure the assembly 100 to the auger 130 through the second member 122.

The actuator 102 may be a motor that is configured to rotate the driver 104, which may be a rack and pinion assembly, connected to the gate 142. Furthermore, the actuator 102 may be paired with a remote control receiver assembly 116 which allows the actuator 102 to be powered on and off remotely. The remote control receiver assembly 116 may receive signals from a remote control unit, not shown in FIG. 1 but shown as element 216 in FIG. 2. In the embodiment shown, the receiver assembly 116 also receives power from a power cord 128 and supplies power to the actuator 102. The actuator 102 is not limited to an electrical motor, but may be any mechanical device that can be used to engage and actuate the driver 104, such as a hydraulic or air driven motor, and may be an electric over hydraulic system.

Between the driver 104 and the actuator 102 there may be a torque limiter, such as a slip clutch 106 which prevents excess force from being applied to the driver 104 by the actuator 102. Excess force from the actuator 102 may cause damage to any of the gate 142, the driver 104, or the actuator 102 itself.

There are also provided components which allow for increased flexibility in the connection between the driver 104 and the actuator 102. Accordingly, there is provided at least one universal joint 108, located between the actuator 102 and driver 104 which allows for variations in connection angle between the assembly 100 and the gate 142. There is also a keyed telescoping assembly 110, such as a driveshaft, which allows for variations in the connection length between the assembly 100 and the gate 142. The keyed telescoping assembly 110 may be mounted between the driver 104 and actuator 102, and there may be a plurality of universal joints between the actuator 102 and the keyed telescoping assembly 110 (for example, joint 108); and/or the driver 104 and the keyed telescoping assembly 110 (for example, joint 112) for increased flexibility.

In another embodiment of the present invention, as shown in FIG. 2, there is another gate control assembly 200 (hereinafter, sometimes simply referred to as “assembly 200”) for a bin 240. The bin 240 has an opening covered by a gate 242 which may be conventionally operated by a driver (not shown). The driver moves the gate 242 between a closed position to substantially block the opening and an open position to permit flow of product into the bin 240 through the opening. A conveyor (not shown) may be positioned to receive product that is released through the opening.

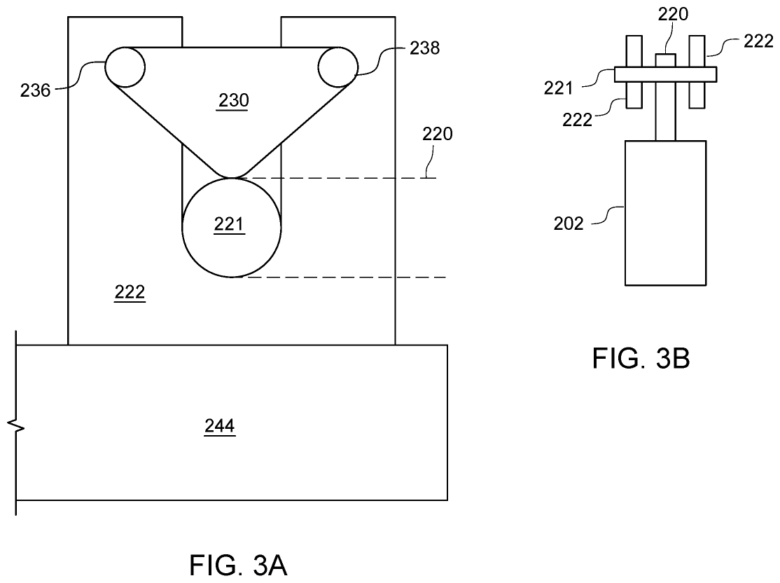

The assembly 200 is mountable to a supporting structure 244, such as a leg of the bin 240. The supporting structure may be any support structure that either outweighs or outmuscles the amount of drag or friction between the slide gate and the product itself in both the opening and closing directions. The assembly 200 may be mounted using detachably interlocking members including a first member 220 and a second member 222, with the first member 220 configured to be mounted on the assembly 200 and the second member 222 mounted on the bin 240. The detachably interlocking members 220 and 222 may allow the assembly 200 to be detached from one bin and quickly installed on another bin with a pre-installed second member 222. Shown in FIGS. 3A and FIG. 3B is one example of such an interlocking system, where a shaft is connected to the actuator 202, the shaft acting as the first member 220, and the shaft is detachably locked in place by a pin 221, which in turn is mounted in a cradle formed by slots defined by each of two elements that together act as the second member 222. These elements are mounted on the supporting structure 244 of the bin 240 itself. As shown in FIG. 3A, connectors 236 and 238 may be, for example, loosely tightened bolts positioning a latch 230 to hold the pin 221 in place. Connectors 236 and 238 may also be different, for example, one being a hinge and the other a fastener. By releasing one of these connectors, the other will hinge allowing the latch 230 to be opened and the pin 221 raised out of the slot. It should be noted that the assembly 200 may also be permanently mounted to the bin 240, without the use of any interlocking system.

According to this embodiment, there is also provided a linear actuator 202 to move the gate 242. The actuator 202 may be connected to the gate using a linear force transmission arrangement. This may be done with a conventionally driven gate regardless of the gate's driving arrangement; in the case of a rack and pinion the rack and pinion will freewheel when the actuator is used. A gate could also be adapted to work with this actuator only, and not have a separate driving arrangement. For a leverage driven gate, the linear actuator could alternatively connect to the lever (not shown) instead of the gate itself.

The linear force transmission arrangement may include a quick attach mount or hard mount. In the embodiment shown, it includes a quick attach mount which may be the same as or different from, but shown as the same as, the quick attach mount comprising members 220 and 222 described above. The linear actuator 202 may be a screw jack configured to provide linear opening and closing force. However, the gate 242 may alternatively also be opened by the application of torque to a driver (not shown in FIG. 2) having a rack and pinion arrangement, where the actuator 202 is a motor configured to rotate a part of the driver. As described above, such a motor may be electric, hydraulic, or air driven. Likewise, the linear actuator described above may be an electric, hydraulic or air driven ram. Furthermore, regardless of the driver arrangement, the actuator 202 may also be paired with a remote control assembly having a remote control 216 which allows the actuator 202 to be powered on and off remotely.

Between the driver 204 and the actuator 202 there is a force limiter, such as a slip clutch where the driver 204 is a rack and pinion arrangement (which, like the linear force transmission arrangement, may also comprise a quick attach mount); or as shown in FIG. 2, a spring loaded clip 206 where the driver 204 is a linear force transmission arrangement. The force limiter prevents excess force from being applied to the driver 204 by the actuator 202, as excess force from the actuator 202 may cause damage to any of the gate 242, the driver 204, or the actuator 202 itself. The force limiter may be adjusted for each bin.

In this embodiment, a visual indication system 218 is also provided, which may display any one of the flow rate (and whether max flow has been achieved), as well as whether the gate 242 is opened or closed. The visual indication system 218 may be a control box that also supplies power or hydraulic fluid/air to the assembly 200 through a cable or hose 232. The visual display allows for greater feedback and control over the flow rate of the product to be conveyed. The visual indication system 218 may include a microswitch 214 mounted between the actuator 202 and the driver 204 and may be connected to the visual indication system 218 using line 234 to control a flow indicator light 224. The microswitch 214 may be configured to detect and convey to the visual indication system 218 the positioning of the actuator 202, the driver 204 and/or the gate 242 to provide feedback on the positioning of the gate 242 and flow rate. The spring loaded clip 206 cooperates with the micro switch 214 upon contact to either set off an indicator light that the gate is open to the desired setting or cuts power to the opening side of the circuit. Preferably, the flow of product out of the bin is based on the speed at which the product conveyor will move it away without spilling on the ground based on various factors including: different augers, different product types and different cleanliness levels required for the product being moved. If the desired setting is exceeded and the spring loaded clip 206 slips from the mount, the light in the visual indication system 218 will reflect the broken circuits which will allow the operator to minimize any product from being spilled on the ground. The visual indication system 218 may also have any one or more of a bin opening light 226, which may for example light up while the gate is in motion moving towards more open, and a bin closing light 228. A flow indicator light may, for example, light up when a desired max flow is reached. The desired max flow may be set up on a bin by bin basis as slidegates vary in size and augers/conveyors vary in transport rate. For example, the max flow may be indicated when the slidegate is fully opened, or when the slidegate is opened to a degree that corresponds to the transport capacity of an auger or conveyor. The maximum flow position may be set by placing a microswitch to be operated when the gate is in the desired maximum flow position.

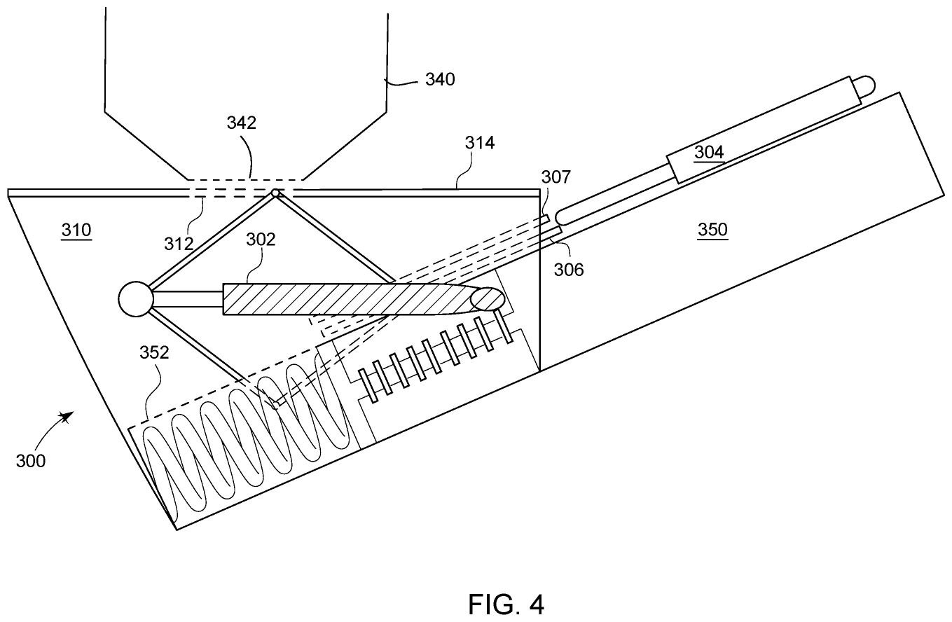

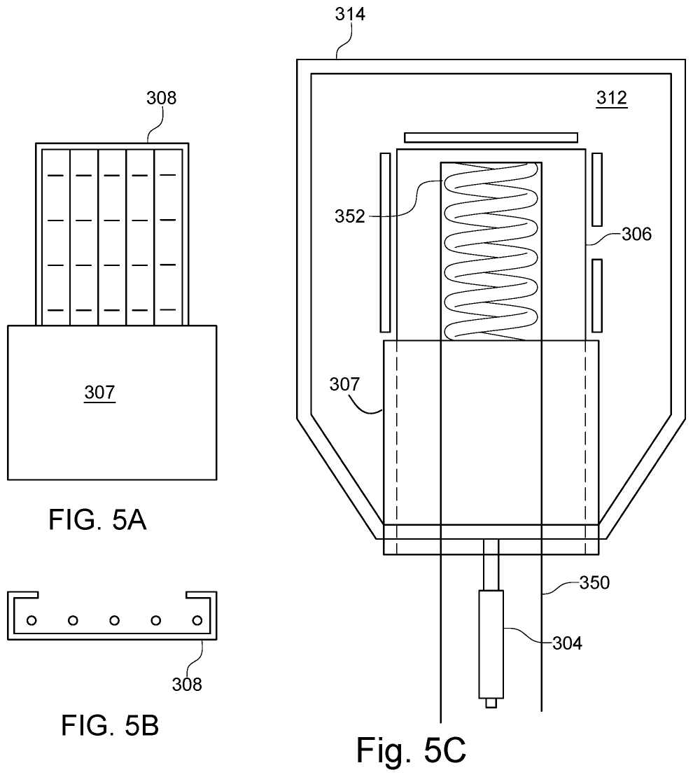

According to yet another embodiment of the present invention, as shown in FIGS. 4-5C, there is provided a hopper assembly 300 for an auger 350 having an opening for receiving a product to be conveyed from a product outlet 342, such as the bottom opening of a trailer hopper 340. As shown in FIG. 4, there is provided a flexible housing 310 (sometimes, simply referred to as “housing 310”) which may be made of a collapsible material such as tarp or shiplap plastic, and which is configured to be mounted over the auger opening 352 (hereinafter, simply referred to as opening 352), to seal the product to be conveyed within the housing 310.

At the top of the housing 310, there is an upper inlet 312 for receiving the product to be conveyed. The upper inlet 312 may be supported by a rigid frame 314, which may be made of a metal material. Preferably, the size of the upper inlet 312 corresponds to the size of the product outlet 342 to prevent any leakage of product between the product outlet 342 and the housing 310 when the upper inlet 312 is in a raised position, as described below.

Also provided within the housing is a first actuator 302 which is designed to effect up and down movement, and is used to raise and lower the upper inlet 312. Accordingly, the upper inlet 312 may be raised against the product outlet 342 leaving zero clearance between the two. This can be used to prevent product overflow and spillage even when the auger 350 ceases operation or is otherwise full. The first actuator 302 may be mounted to the auger 350 using a friction fit, as described above in the other exemplary embodiments.

There is also provided a second actuator 304 which is connected to a gate 306. The gate 306 is designed to be able to cover the opening 352 of the auger 350. The second actuator 304 moves the gate 306 between a closed position to substantially block the opening 352 of the auger 350, and an open position to permit flow of product into the opening 352 of the auger 350. The gate 306 may be a sliding gate which is extended and retracted by the second actuator 304. The movable gate 306 may be further covered by a stationary flat plate 307 that allows the gate 306 to slide under it.

Furthermore, as shown in FIG. 5A, there may be a filter 308 which is mounted over the opening 352 of the auger 350, but below the gate 306, which can act as a coarse filter for removing large undesirables, while also acting as additional support for the gate 306. Alternatively, the filter 308 may be mounted above the gate 306 to function as a filter for seed and fertilizer. In FIG. 5A, a top view of the stationary flat plate 307 and filter 308 is shown separate from the housing for clarity. FIG. 5B shows a side view of the filter 308. A top view of the apparatus more broadly, omitting the filter 308, is shown in FIG. 3C.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A trailer hopper having a gate and gate control assembly, the gate having a closed position and an open position, the gate control assembly having a length, the trailer hopper having an auger and the gate control assembly comprising:
an actuator mounted on the auger or the trailer hopper;
a driver adapted to be secured to the gate, the actuator being connected to the driver to operate the driver through a keyed telescoping assembly for adjusting the length of the gate control assembly; and
one or more universal joints between the actuator and the driver.

2. The trailer hopper of claim 1, further including a torque limiter located between the driver and the actuator.

3. The trailer hopper of claim 1, wherein one universal joint of the one or more universal joints is located between the driver and the keyed telescoping assembly.

4. The trailer hopper of claim 1, wherein the driver comprises a rack and pinion arrangement, a rack, of the rack and pinion arrangement, being on the gate.

5. The trailer hopper of claim 1, wherein the one or more universal joints comprise a first universal joint and a second universal joint.

6. The trailer hopper of claim 1, wherein the actuator is mounted using detachably interlocking first and second members, the first member configured for attachment to the actuator and the second member is configured for attachment to the auger.

7. The trailer hopper of claim 1, wherein the torque limiter comprises a slip clutch.

8. The trailer hopper of claim 1, further comprising a remote control assembly attachable to the actuator.

9. The trailer hopper of claim 1, wherein the actuator is mounted on the auger.

10. The trailer hopper of claim 9, wherein the actuator is mounted on the auger through a friction fit.

11. A gate control assembly for use with a bin having a gate, the gate having a closed position and an open position, the gate control assembly having a length and comprising:
an actuator mountable on the bin;
a driver adapted to be secured to the gate;
a force limiter mounted between the actuator and driver; and
a visual indication system for displaying any one of flow rate, and the positioning of the gate.

12. The gate control assembly of claim 11, in which the driver comprises a lever arrangement, the lever arrangement being connectable to the gate.

13-16. (canceled)

17. The gate control assembly of claim 11, wherein the actuator is mounted using detachably interlocking first and second members, the first member configured for attachment to the actuator and the second member configured for attachment to the bin.

18. The gate control assembly of claim 11, wherein the visual indication system comprises a position detecting microswitch mounted between the actuator and driver.

19. The gate control assembly of claim 11, further comprising a remote control assembly attached to the actuator.

20. A hopper assembly for an auger, the auger having an opening for receiving a product to be conveyed from a product outlet, the hopper assembly comprising:
a flexible housing having an upper inlet, the housing disposed above the opening of the auger;
a first actuator in connection with the housing, the first actuator configured to lower and raise the upper inlet of the housing;
a gate mountable over the opening of the auger; and
a second actuator configured to move the gate between an open position and a closed position.

21. The hopper assembly of claim 20, wherein the housing comprises a rigid frame supporting the upper inlet.

22. The hopper assembly of claim 20, wherein the gate comprises a sliding gate, and the second actuator is configured to extend and retract the gate.

23. The hopper assembly of claim 20, wherein any one of the first actuator and second actuator are mountable to the auger.

24. The hopper assembly of claim 20, further comprising a filter configured to cover the opening of the auger.
